(19) United States
(12) Patent Application Publication
(10) Pub. No.: US 2009/0113820 A1
(43) Pub. Date: May 7, 2009

(54) PREFABRICATED WALL PANEL SYSTEM

(76) Inventor: Scott Deans, Altamonte Springs, FL (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 12/261,888

(22) Filed: Oct. 30, 2008

Related U.S. Application Data
(60) Provisional application No. 60/983,773, filed on Oct. 30, 2007.
(60) Provisional application No. 61/060,946, filed on Jun. 12, 2008.

(51) Int. Cl. E02D 19/00; E04C 2/38; E04B 1/18; E06B 7/14

(52) U.S. Cl. 52/169.14; 52/800.1; 52/274; 52/309.4; 52/220.1; 52/235; 52/653.1; 52/209

(57) ABSTRACT

A prefabricated wall system used in constructing a structure, the system including a wall segment configured to be lightweight and easily handled manually while constructing the structure, and a securing system configured to secure the wall segment in place on the structure.

### CROSS-REFERENCE TO RELATED APPLICATIONS

This application claims the benefit of U.S. Provisional Application No. 60/983,773 filed Oct. 30, 2007, and incorporated herein by reference in its entirety.

This application claims the benefit of U.S. Provisional Application No. 61/060,946 filed Jun. 12, 2008, and incorporated herein by reference in its entirety.

### FIELD OF INVENTION

The present invention relates to building construction and, more particularly, to a prefabricated building wall section system for use in replacing concrete blocks.

### BACKGROUND OF THE INVENTION

Typical building construction uses concrete blocks that are individually set in mortar to construct walls of a building. These blocks are nominally 8×8×16 inches when measured with the associated mortar joints. Each block weighs about 40 pounds and the laying of the blocks to create a wall is a labor intensive task. Various methods have been proposed to overcome the labor issues involved in laying block, including creating forms and pouring solid concrete walls. Other proposals have used prefabricated wall panels such as foam core panels that can be put in place and then sprayed with a concrete surface. It has also been proposed to prefabricate a foam core panel with outer concrete surfacing that can be lifted in place using lifting apparatus at the job site. However, recent changes in building codes have required that building walls have sufficient strength to withstand winds associated with hurricanes and tornados.

### BRIEF DESCRIPTION OF THE INVENTION

A prefabricated wall system used in constructing a structure is disclosed. The system has a wall segment configured to be lightweight and easily handled manually while constructing the structure. A securing system is disclosed being configured to secure the wall segment in place on the structure.

### BRIEF DESCRIPTION OF THE DRAWINGS

A more particular description of the invention briefly described above will be rendered by reference to specific embodiments thereof that are illustrated in the appended drawings. Understanding that these drawings depict only typical embodiments of the invention and are not therefore to be considered to be limiting of its scope, exemplary embodiments of the invention will be described and explained with additional specificity and detail through the use of the accompanying drawings in which:

FIG. 1 is a composite view of all of the individual elements that are joined together to form a prefabricated wall section;

FIG. 2 shows the components of the wall section of FIG. 1 as they are assembled to form a wall section;

FIG. 3A shows an exemplary embodiment of the components of another wall section as components are assembled to form the wall section;

FIG. 3B shows an exemplary embodiment of additional components of the wall section illustrated in FIG. 3A as components are assembled to form the wall section;

FIG. 4A shows an exemplary embodiment of the components of another wall section as components are assembled to form the wall section;

FIG. 4B shows an exemplary embodiment of additional components of the wall section illustrated in FIG. 4A as components are assembled to form the wall section;

FIG. 5 shows an exemplary embodiment of the components of another wall section as components are assembled to form the wall section;

FIG. 6 illustrates an assembly of the wall sections to form a wall;

FIG. 7 illustrated an assembly of the wall section upon a floor;

FIG. 8 illustrates a final wall assembly;

FIG. 9 is a partial cutaway and external view of a wall assembly using a concrete post and beam application;

FIG. 10 is a partial cutaway and external view of a wall assembly using a steel post and beam application;

FIG. 11 illustrates a wall assembly with a window;

FIG. 12 illustrates details of a portion of the wall assembly;

FIG. 13 is a cross-sectional view of the window installation in the wall assembly;

FIG. 14 illustrates a starter block used to minimize water incursion into a structure;

FIG. 15 illustrates the use of the starter block in a wall structure;

FIG. 16 is an enlarged cross-sectional view of the starter block and wall assembly;

FIG. 17 shows one form of sill board for use in the window structure of FIG. 13;

FIG. 18 is a cross-sectional view of a wall segment arrangement of FIGS. 3A and 3B.

FIG. 19 is a cross-sectional view of a wall segment arrangement of FIGS. 4A and 4B.

FIG. 20 is a cross-sectional view of a wall segment arrangement of FIG. 5.

FIG. 21 is a cross-sectional view of another exemplary wall segment;

FIG. 22 is a cross-sectional view of another exemplary wall segment arrangement; and

FIG. 23 is a cross-sectional view of another exemplary wall segment arrangement.

### DETAILED DESCRIPTION OF THE INVENTION

Reference will now be made in detail to the embodiments consistent with the invention, examples of which are illustrated in the accompanying drawings. Wherever possible, the same reference numerals used throughout the drawings refer to the same or like parts.

Though exemplary embodiments of the present invention are described with respect to concrete post and beam construction, the exemplary embodiments disclosed herein are also applicable for steel post and beam construction. Towards this end, the exemplary embodiments of the present invention is applicable for a plurality of uses, including but not limited to high rise structural construction other uses, where improved wind load tolerances and reduced effects of seismic activity is realized.

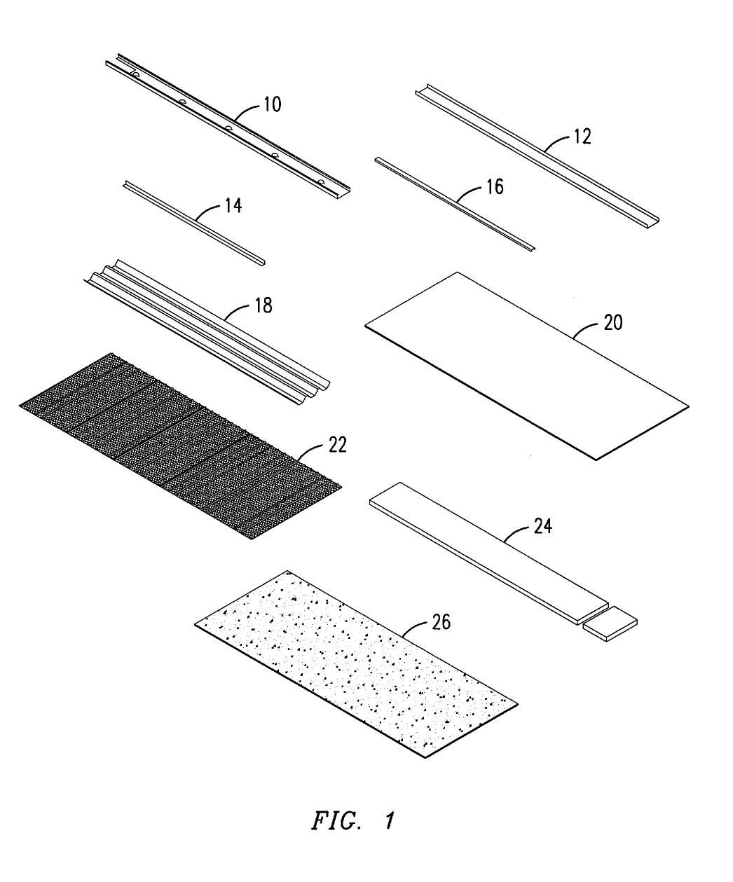

Turning now to FIG. 1, the various components that make up the inventive wall section are each illustrated as individual items in this figure. Each of the items are previously cut or sized to fit a particular desired dimensional wall section, such as but not limited to a 5×9 or 4×8 section. As shown in FIG. 1, the individual pieces comprise a metal stud 10 which extends through the longest length of the wall section and a metal track 12 which is used to join the completed sections or panels. The panels use metal channels 16 and angle bars 14 to join the metal studs 10 into a rectangular configuration. The components also include a corrugated galvanized steel panel 18 between the metal studs. The remaining components include a thermal ply layer 20 which is attached to one side of the assembled metal studs. A rib lathe 22 is fastened to the outer exposed area of the thermal ply layer to form a surface for receiving stucco or other outer material such as lightweight concrete. Insulation 24 is placed between the studs 10. A lightweight concrete drywall panel 26 may be poured in situ over the rib lathe 22 to form the panel.

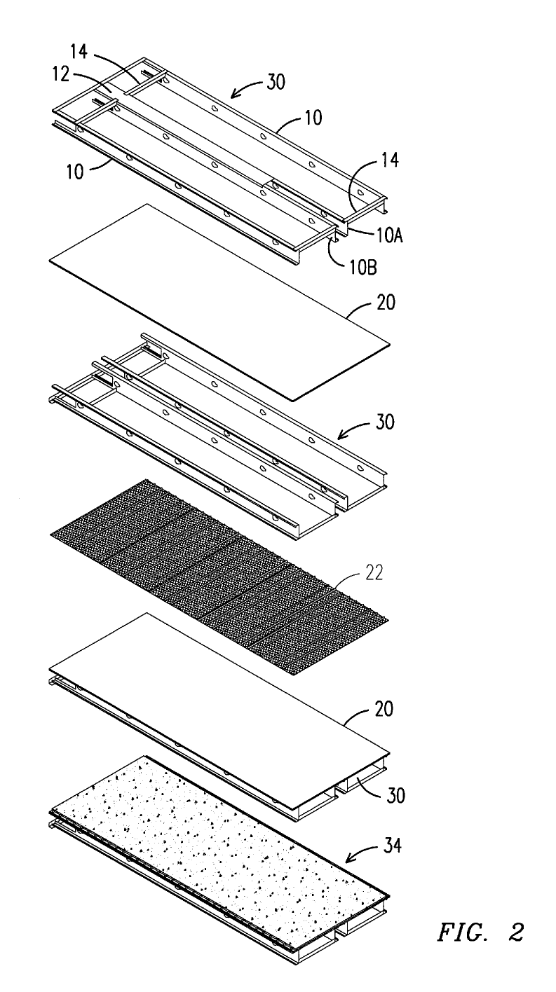

Referring to FIG. 2 at 30 there is shown an assembly of the metal studs 10 fastened together at opposite ends by transverse angle bars 14. In addition, the center studs 10a and 10b are fastened together by means of the metal track 12. The combination of the studs 10, track 12, and angle bars 14 forms a skeleton structural unit 30 which is the basis for the wall panel. The bars 14 are fastened to the studs along one edge and then the assembly 30 is inverted to receive the thermal ply outer panel 20. The panel 20 is attached to the framework 30 by screws or other suitable means well known in the art. The rib lathe 22 is then attached to the thermal ply layer by screws to form a bonding surface for the lightweight concrete panel 26. The lightweight concrete panel indicated at 26 in FIG. 1 is formed on the assembly 32 by placing the assembly in a form and pouring the concrete over the rib lathe.

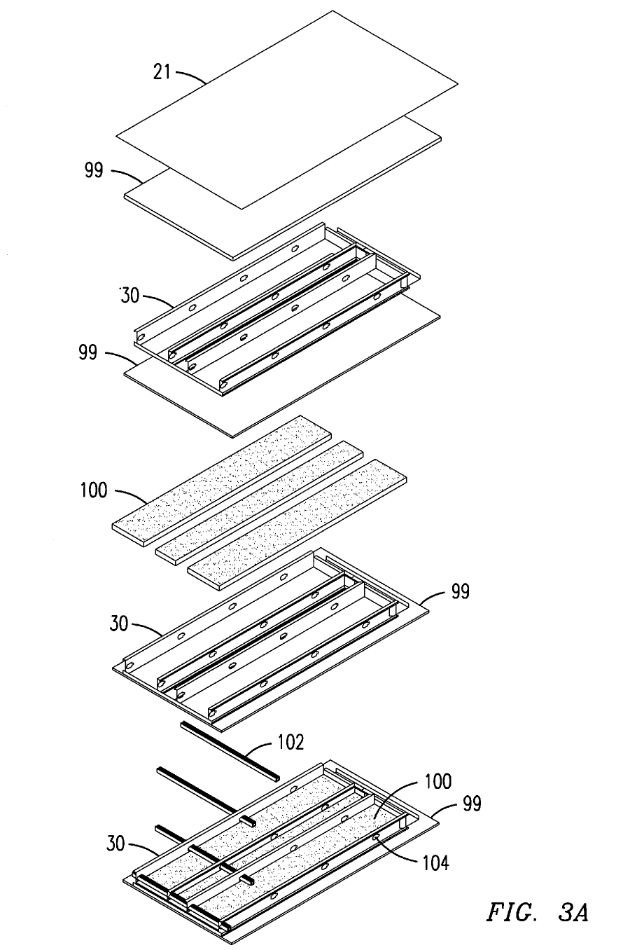

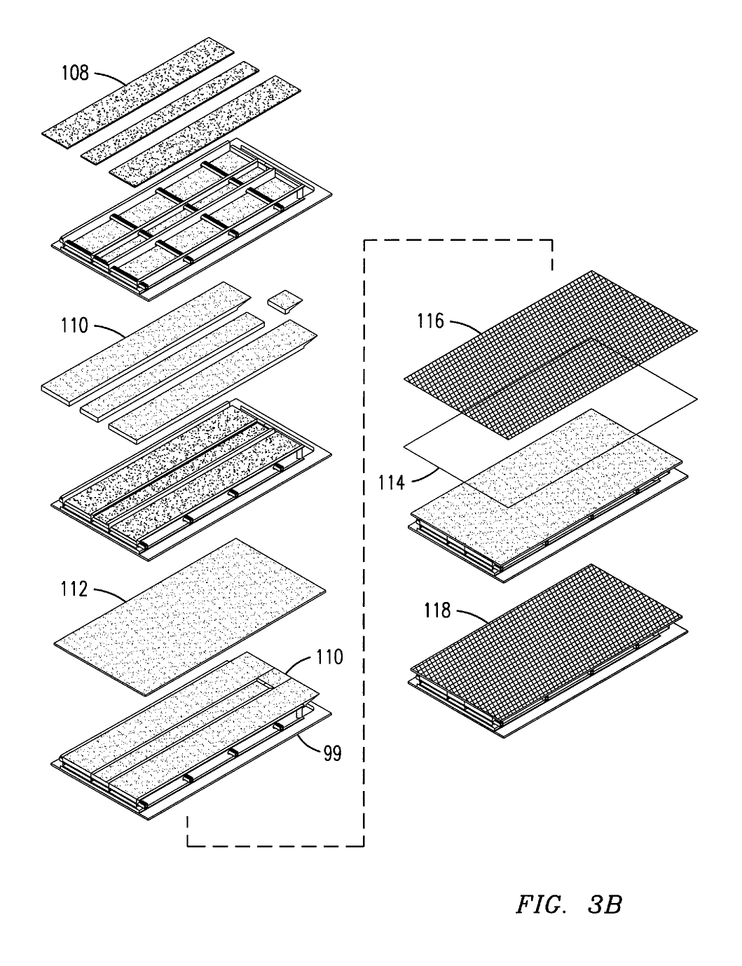

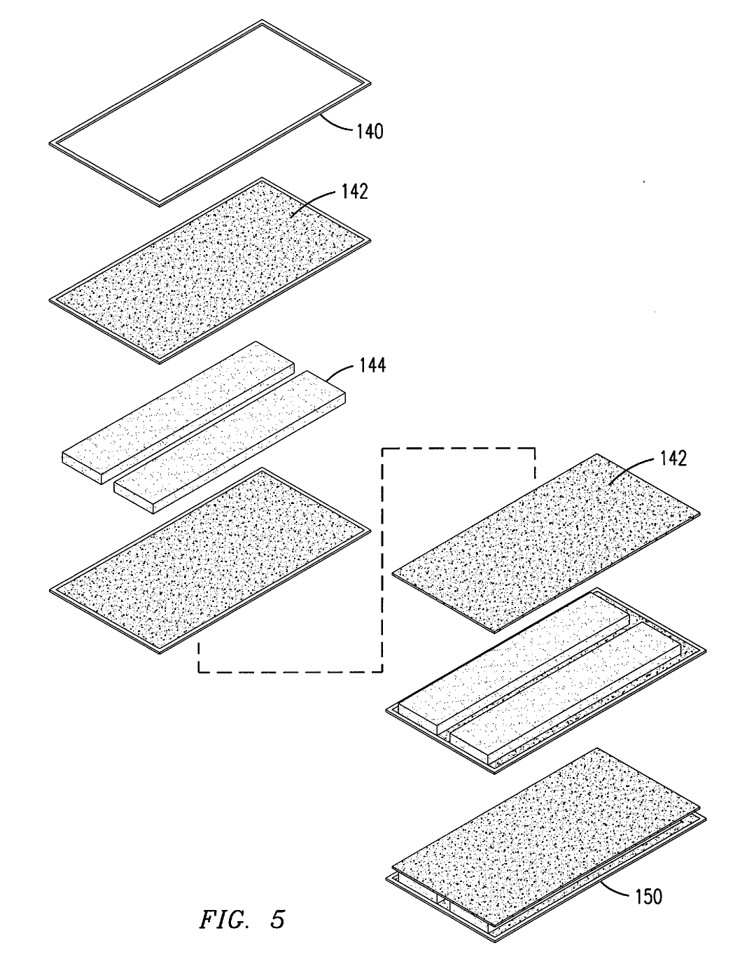

FIGS. 3A and 3B show exemplary embodiment of the components of another wall section as components are assembled to form a wall section. As illustrated in FIG. 5A, a vapor barrier, such as but not limited to Visqueen®, stretched over a mold 99. The framework 30 is secured to the mold 99. Foam insulation 100 is inserted into the openings in the framework 30. Plumbing and electrical conduits 62, such as but not limited to cold rold channels and electrical chases, are installed into the framework 30. As illustrated holes 104, or openings, are formed through the framework 30 to accommodate the conduits 102.

Turning to FIG. 3B, a thermal ply layer 108 is attached over the opening where the conduits 102 are visible between the framework 30. A second layer of foam insulation 110 is attached to the thermal ply layer 108 and the framework 30. A third piece of foam insulation 112 is installed over the framework 30. Whereas the first and second layers of foam insulation 100, 110 are multi-faceted pieces configured to fit within openings in the framework 30, the third layer of insulation 112 is a solid piece configured to cover the exposed edge of the framework 30, furthest away from the mold 99. As further illustrated, a home wrap, Visqueen® or another coating, 114 is stretched and secured to the third layer of foam insulation 112. A lath 116 is then placed over the home wrap 114 and attached to the framework 30 and/or third layer of insulation 112, collectively forming a wall segment 118.

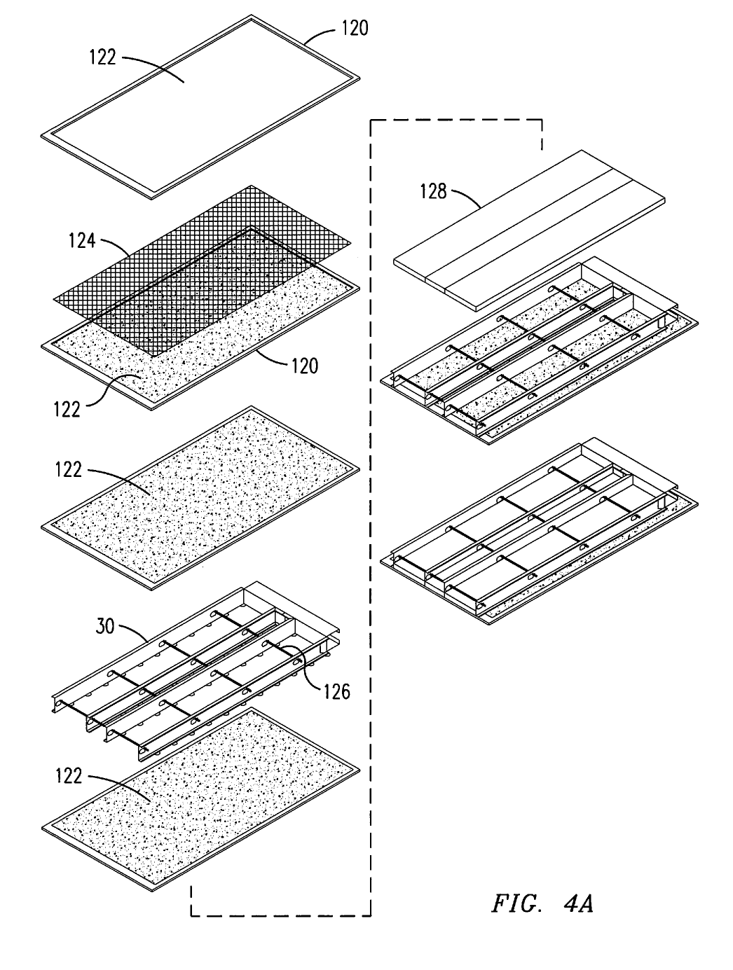

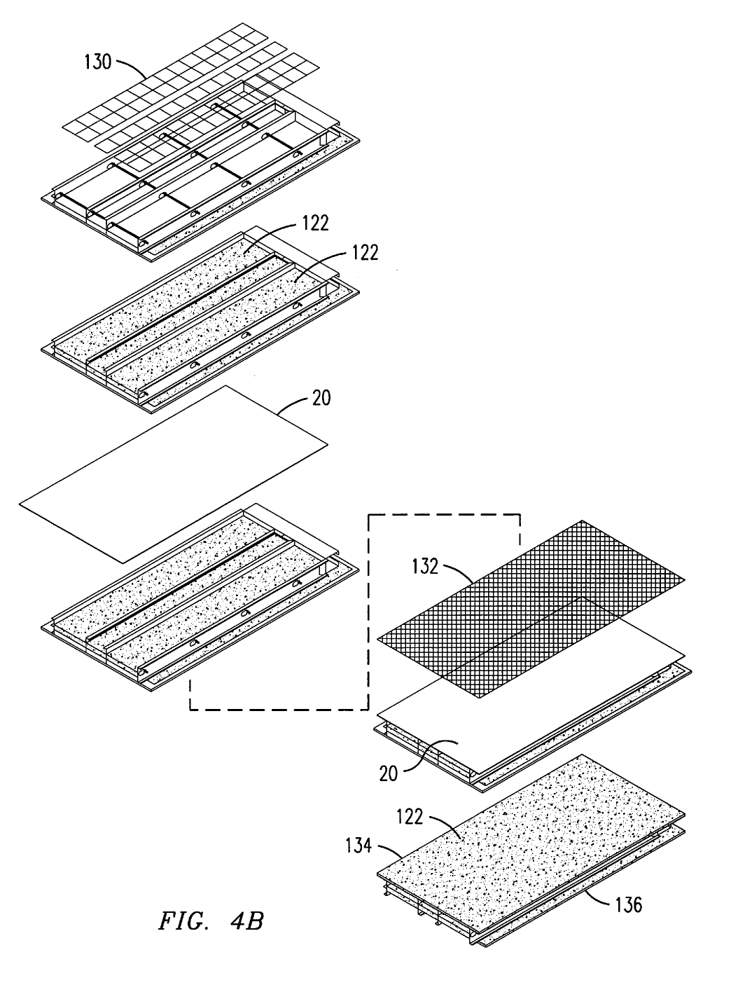

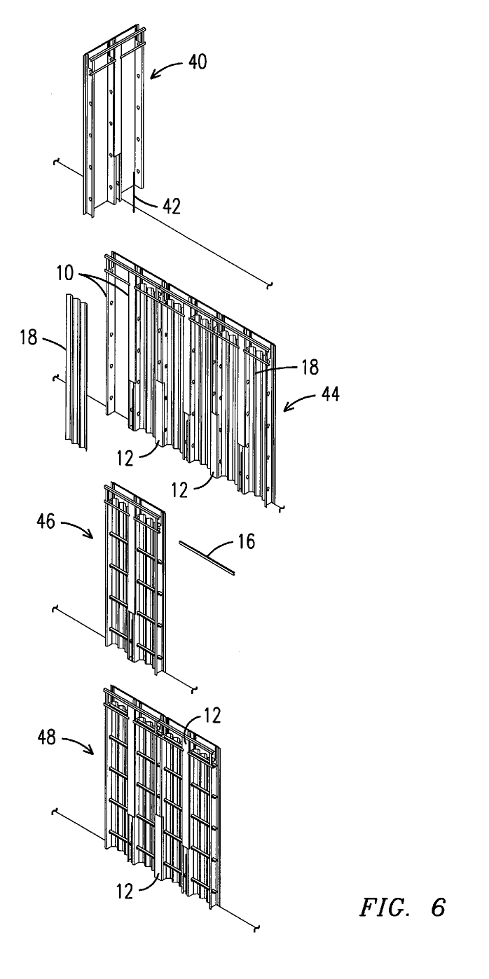

FIGS. 4A and 4B show exemplary embodiment of the components of another wall section as components are assembled to form the wall section. As illustrated in FIG. 6A, a mold 120 is coated with a lightweight concrete coating 122, such as but not limited to the lightweight concrete coating disclosed in U.S. patent application Ser. No. 12/166,494, filed Jul. 2, 2008, herein incorporated by reference. A mesh panel 124 is inserted into the poured concrete 122. The mesh panel 124 may be made of a metal and/or a plastic material. The mesh panel 124 is further covered with the lightweight concrete 122 and the concrete is then leveled off. A framework 30 is fixed within the concrete 122. The framework 30 has threaded rods 126, such as but not limited to steel rods, inserted through the framework 30. The threaded rods 126 are provided to apply tension within the core of the finished wall segment. Application of tension to the rods 126 significantly increases strength and surface impact resistance. A temporary mold 128 is formed by placing a removable material, such as but not limited to Styrofoam® beneath the threaded steel rods 126. Though Styrofoam® is disclosed, the type of material used is a material to define an area during construction of the wall.

Turning to FIG. 4B, a second layer of mesh 130 is placed in the openings of the framework 30, over the threaded rods 126. Another layer of lightweight concrete 122 is then poured within the openings of the framework 30. A thermal ply 20, such as but not limited to a single piece, is secured over the framework 30. A lathe 132 is fastened to the framework 30, over the thermal ply. A foam board 134 is installed and then a final layer of the lightweight concrete 122 is applied. After the concrete 122 has set, the formboards 134 and Styrofoam molds 128 are then removed, forming the wall segment 136. This configuration has no foam insulation. Therefore, toxic fumes are eliminated in case of a fire.

FIG. 5 shows exemplary embodiment of the components of another wall section as components are assembled to form the wall section. A mold 140 is provided. Either lightweight concrete or another type of board, such as but not limited to a Magnesium Oxide board, 142 is installed in the mold 140. Foam insulation 144 is attached to the concrete/board 142. A top surface of the wall segment has a concrete layer and/or the magnesium oxide board 144. Such a wall segment 150 is lightweight and has a high R-value rating. An R-value rating is based on a measure of thermal resistance used to compare insulating values. The higher the R-value of a material, the better its insulating capability. Additionally, such a wall segment 150 has high impact resistant qualities while being flexible.

At a construction site, the individual panels indicated at 34 in FIG. 6 are assembled by joining the ends of the panels together using the metal tracks 12. The tracks 12 are screwed to the studs 10 using conventional metal screws designed for this purpose. As shown at 40 in FIG. 6, the initial panel stands on end and is positioned over a vertically extending reinforcement bar and then rotated around the rebar and slid into position so that the panel is actually connected to the reinforcing bar indicated at 42. A plurality of the panels 40 is then sequentially placed adjacent each other and joined together by the metal tracks 12 as indicated at 44. The corrugated galvanized steel indicated at 18 in FIG. 1 is inserted into the wall panels between each of the pair of parallel studs 10. Once the corrugated galvanized steel panels 18 are positioned between the studs 10, a one and one-half inch metal channel is slid through the holes that are conventionally formed in the metal studs and rotated to lock the studs and corrugated steel in place as shown at 46. As each of the preformed panels is slid into place and attached to an adjacent panel by means of the six inch track 12, a space is formed between the adjacent panels that can be used to receive concrete so that the wall is joined by formed in place concrete piles between each of the pairs of panels.

The individuals panels, or wall segments indicated at 34, in FIG. 2, 118 in FIG. 3B, 136 in FIG. 4B, and 150 in FIG. 5 can be installed in a similar manner as disclosed above. In another exemplary embodiment, illustrated in FIG. 7, once a floor 152 is laid for a building structure, the track 156, such as but not limited to a steel track, is secured to the floor 152. The steel track 156 is segmented by tenants 158, such as but not limited to steel tenants. The wall segments 34, 136, and 150 are positioned on the tracks 156 therebetween the tenants 158. A tubing 160, such as but not limited to a vertical steel tubing, is placed between adjacent wall segments, and a horizontal tubing 162, such as but not limited to a steel horizontal tubing, is secured above the wall segment.

Turning now to FIG. 8, at 50, in another exemplary embodiment, there is shown upper and lower reinforcing bars 52 extending lengthwise across the top of the assembled panels so that a concrete tie-beam can be poured in place across these panels and joined by the reinforcing bar extending crosswise of the panels. The reinforcing bars 52 are conventional reinforcing bars used in wall construction. At 54 there is shown a further step in the assembly in which the insulation material 24 is pushed in place between the vertical studs 10. Note that the insulation 24 is in two pieces, one long piece and one short piece to accommodate the joint formed at the top of the studs by the crossing angle bar 14. Once the insulation has been placed between the studs as indicated at the assembly 56, the concrete reinforcement can be pumped into the down cells formed between adjacent panels by tracks 12 and into the top area in which the reinforcing bar 52 is located so that the down cells and cross tie-beam are integrally joined. Finally, the wall 58 can be completed by conventional attachment of a drywall panel 60 to the inside of the walls overlaying the insulation material 24.

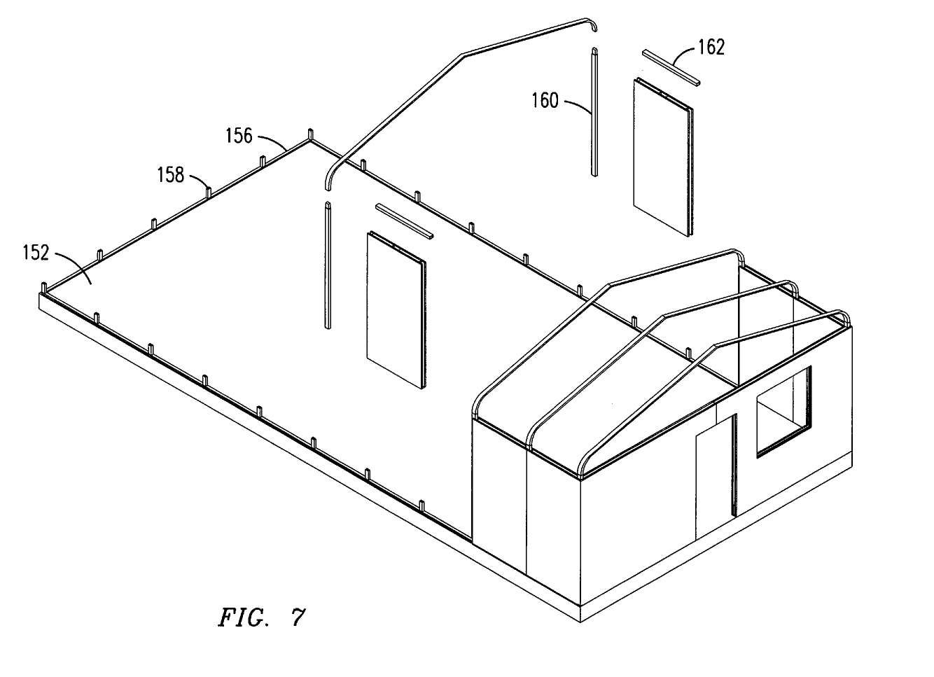

As disclosed herein, the wall segments are utilized with a concrete and/or steel post and beam application. FIG. 9 discloses a wall where a concrete post and beam application is used. Once the walls are in place, such as secured to the track 156, concrete, reinforced concrete, is poured therebetween adjacent wall segments to form the post 165. A concrete beam 166, with reinforced concrete, is poured horizontally across the top of the wall segments. An upper track 157 is provided to define the location where the cement is poured forming the concrete beam 166.

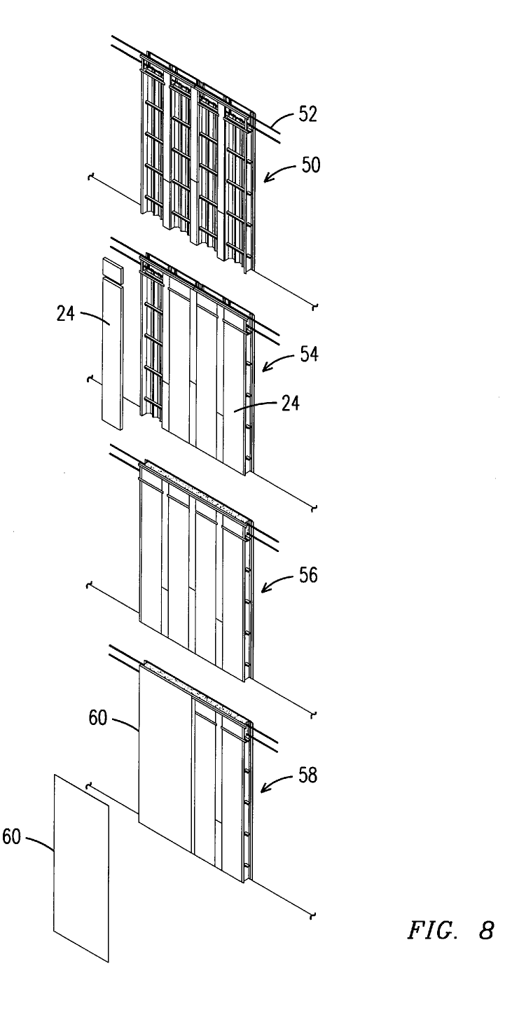

FIG. 10 discloses a wall where a steel post and beam application is used. In this embodiment, the steel posts 170 are secured in place after the floor is poured. The wall segments are lifted over the steel posts and are lowed down into position. The walls are then bolted to the steel beam 172 once it is placed on top of the wall segments. Those skilled in the art will readily recognize that a plurality of various wall segments, such as but not limited to those disclosed herein, may be utilized for the wall segments.

FIG. 11 shows how a window and hurricane shutter assembly can be incorporated in the wall section. In this example, the wall section is formed of two spaced cementious panels 70 and 72 with Styrofoam filler 76 between the panels. A poured concrete tie beam across the top of the wall at 74 provides structural strength. Again, those skilled in the art will readily recognize that a plurality of various wall segments, such as but not limited to those disclosed herein, may be utilized for the wall segments.

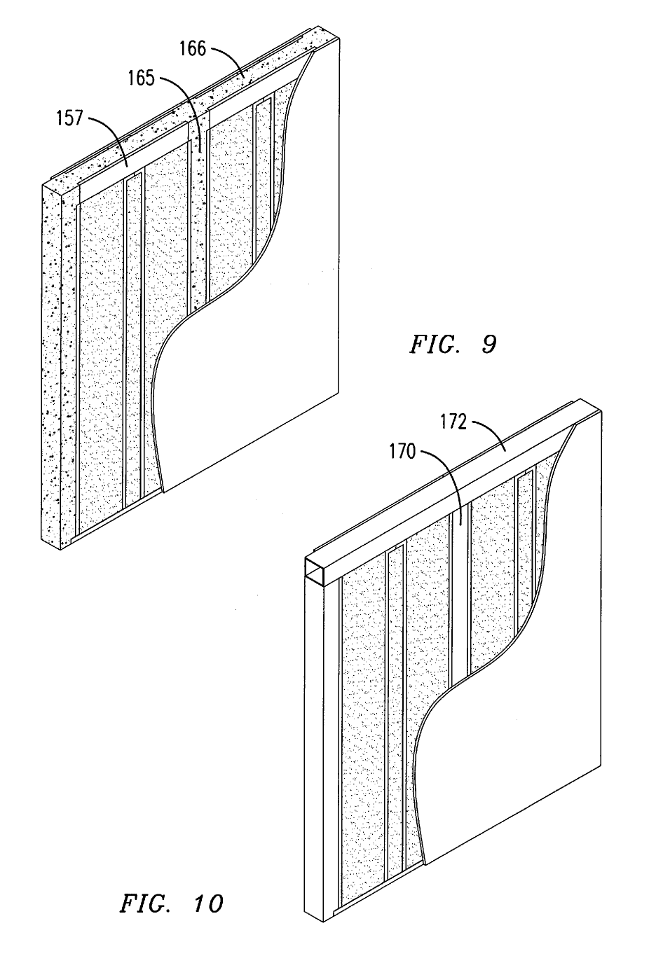

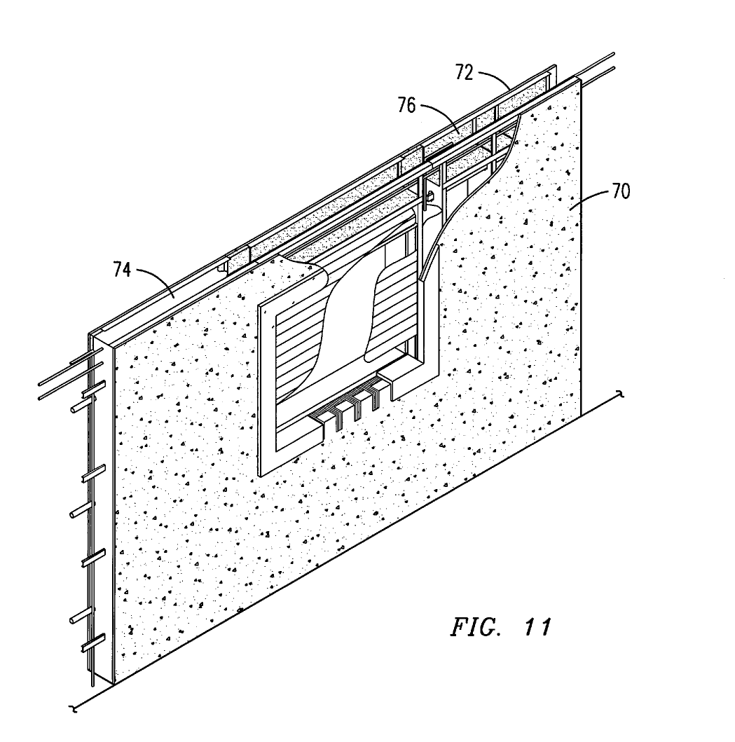

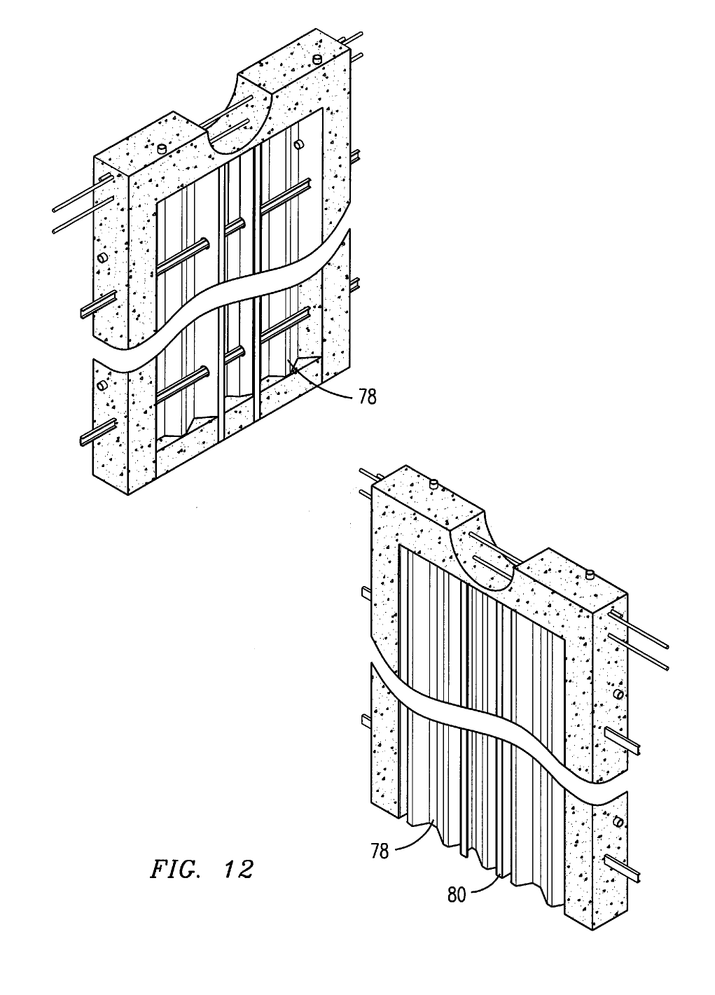

FIG. 12 shows detail of another form of the wall structure in which the wall is made up of multiple segments each defined by a concrete header, footer and side beams. Between these concrete elements, the wall is formed by a corrugated steel panel 78 mounted to the vertically oriented metal studs 80.

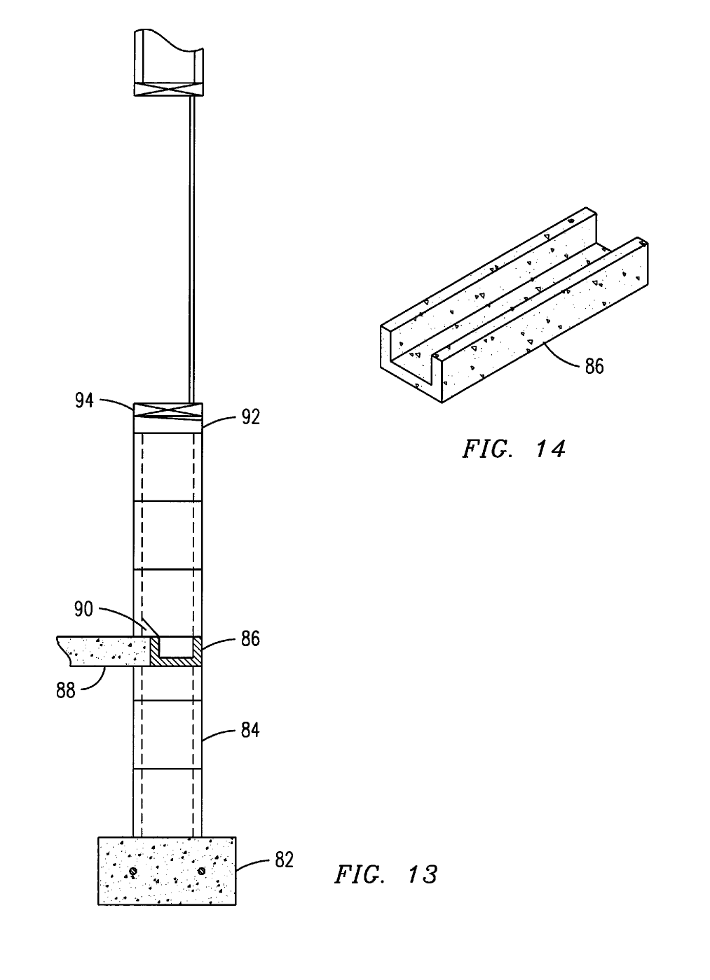

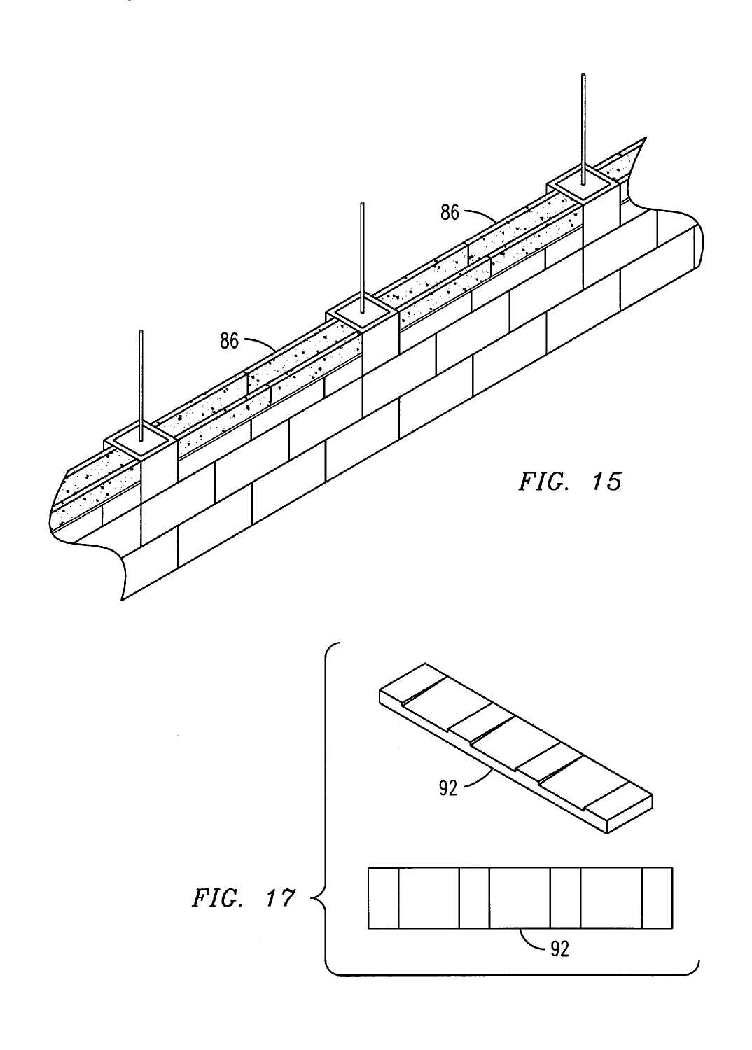

FIG. 13 is a cross-sectional view of the window arrangement of FIG. 11 illustrating a structure in which the building base is built on a footer 82 and raised to ground level or above by conventional concrete blocks 84. A starter block 86 is placed on the blocks 84 at the level of the concrete slab 88. The wall panels 58 are then erected on the starter block 86 with a beveled mud set at 90. Along the bottom of the window opening there is beveled window sill 92 and a buck strip 94. Details of the sill 92 are shown in FIG. 17. The sill forces the penetrating water to drain to the exterior. Details of the starter block 86 are shown in FIG. 14. This block serves as a formboard and a recessed trap to catch water that penetrates through the outer wall. The starter block is formed of a material that absorbs the water and releases it below ground level. FIG. 15 provides a better view of the arrangement of the starter blocks 86 along a support wall.

FIG. 16 is an enlarged view of the interface of the wall section 58 with the starter block 86 at slab level. It should be noted that the beveled concrete insert 90 locks the bottom of the wall panel to the slab.

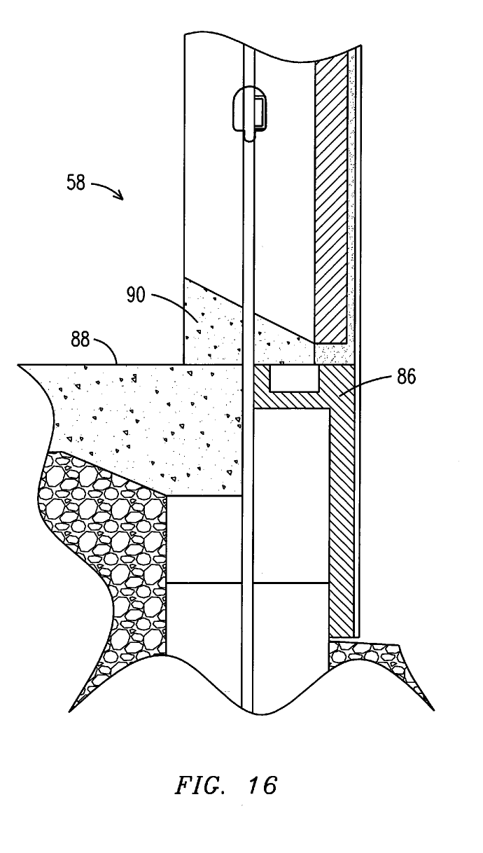

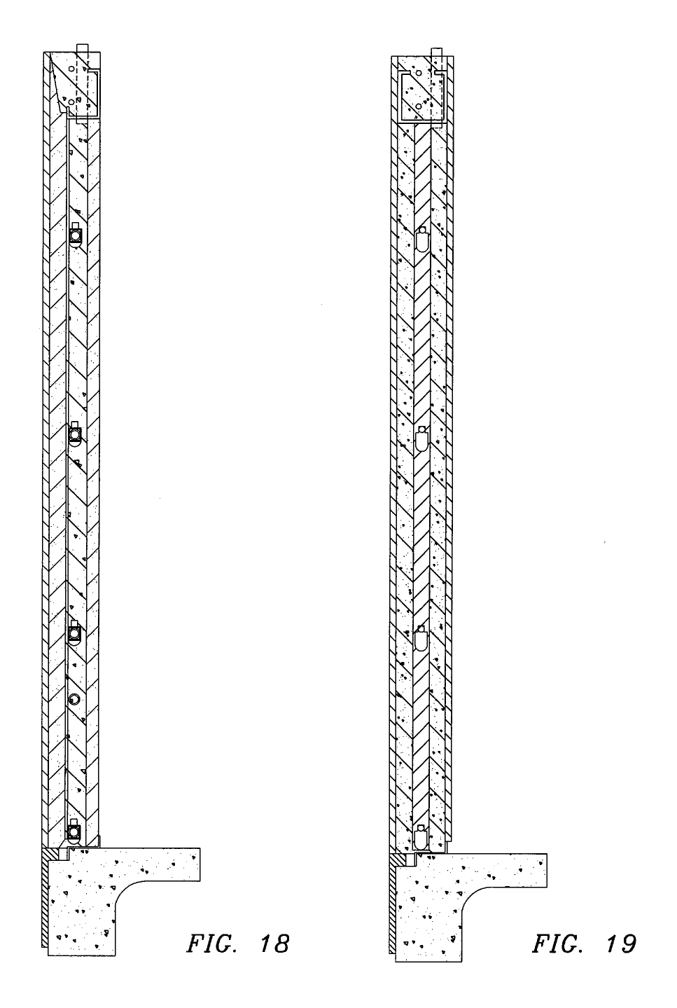

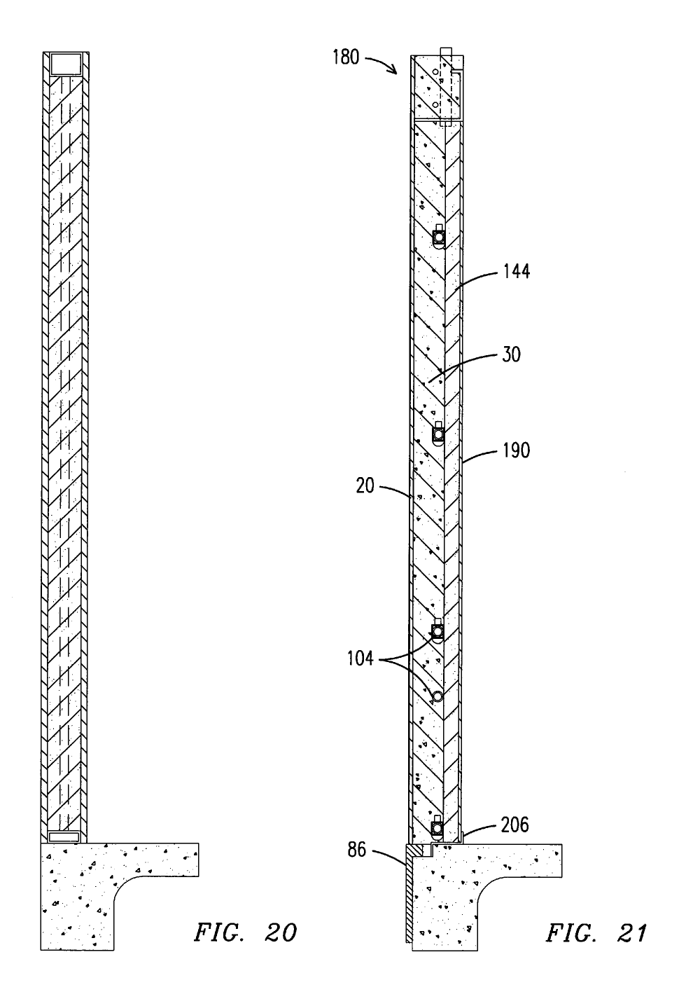

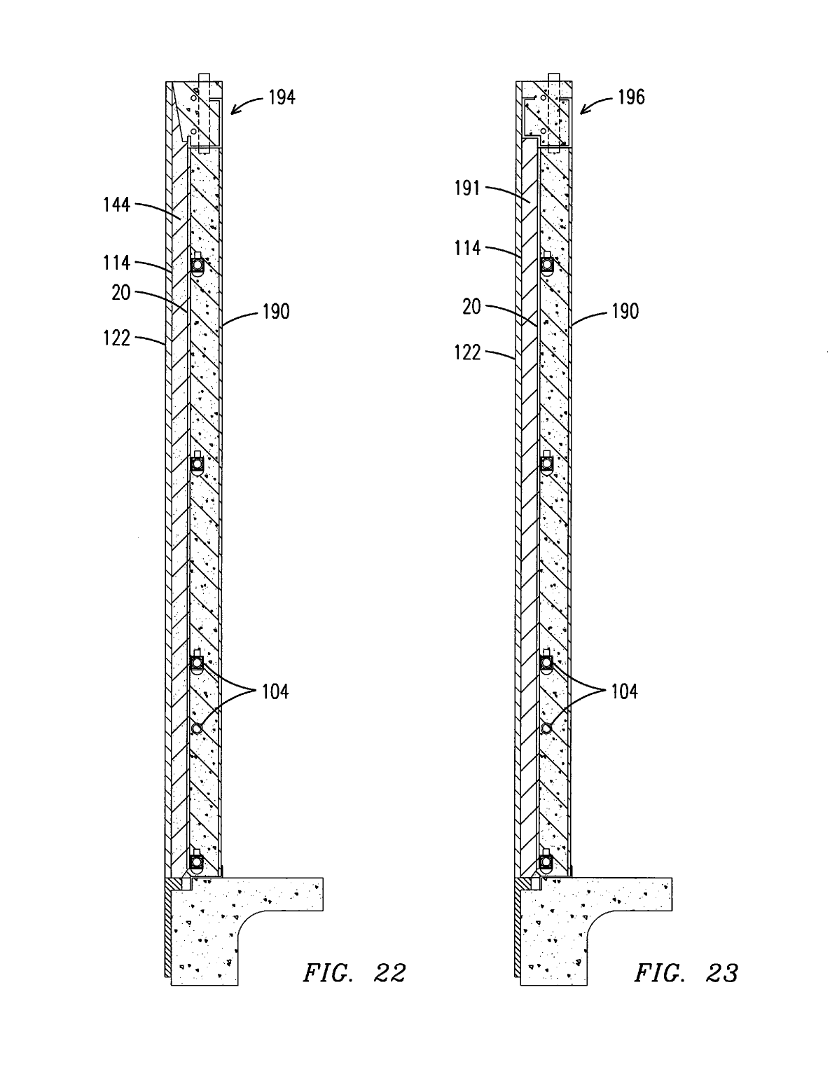

FIG. 18 is a cross-sectional view of a wall segment arrangement of FIGS. 3A and 3B. FIG. 19 is a cross-sectional view of a wall segment arrangement of FIGS. 4A and 4B. FIG. 20 is a cross-sectional view of a wall segment arrangement of FIG. 5. FIG. 21 is a cross-sectional view of another wall segment. This wall segment 180 has a thermal ply barrier 20 next to the framework 30. Foam insulation 144 is next to the other side of the framework 30 and the last layer is a vapor barrier 190. As disclosed herein with respect to the other wall segments, opening 104 for electrical connections and plumbing are also provided. FIG. 22 is a cross-sectional view of another wall segment arrangement. This wall segment 194 has a lightweight concrete coating 122 next to a foam insulation 144. The next layer is a thermal ply 20, followed by the framework 30. A vapor barrier 190 is the final layer. FIG. 23 is a cross-sectional view of another wall segment arrangement. This wall segment 196 has a lightweight concrete coating 122 next to corrugated steel 191. A thermal ply layer 20 is then provided. Foam insulation 144 is then provided, followed by the framework 30. As illustrated two levels of foam insulation 144 are used. A vapor barrier 190 is the final layer. Also displayed in FIGS. 18 though 23 are rebar 201, the concrete beam 166, the steel upper track 157, and a top plate 203. In each configuration, the wall segment is fixed to the starter block 86 and to the foundation or floor 152, including Z-flashing 206 between the foundation 152 and wall segment.

While the invention has been described with reference to various exemplary embodiments, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A prefabricated wall system used in constructing a structure, the system comprising:
a wall segment configured to be lightweight and easily handled manually while constructing the structure; and
a securing system configured to secure the wall segment in place on the structure.

2. The prefabricated wall system according to claim 1, wherein the securing system further comprises a track system secured to a foundation of the structure onto which the wall segment is secured.

3. The prefabricated wall system according to claim 2, wherein the securing system further comprises at least one tenant that extends from the track to further secure the wall segment to the foundation.

4. The prefabricated wall system according to claim 1, wherein the securing system further comprises a starter block configured to further secure the wall segment to a foundation of the structure.

5. The prefabricated wall system according to claim 4, wherein the starter block is further configured to minimize water incursion into the structure.

6. The prefabricated wall system according to claim 1, wherein the wall segment further comprises a window cutout through which a window is located.

7. The prefabricated wall system according to claim 6, further comprising beveled window sill and a buck strip wherein the window sill is configured to force the penetrating water at the window to drain to an exterior of the wall segment.

8. The prefabricated wall system according to claim 1, wherein the wall segment comprises a metal frame with foam insulation positioned between openings of the metal frame and over a side of the metal frame, a thermal ply layer, a vapor barrier defining a first external side and a lath defining a second external side.

9. The prefabricated wall system according to claim 1, wherein the wall segment comprises channels formed therethough the wall segment for placement of a plumbing line and/or an electrical conduit.

10. The prefabricated wall system according to claim 1, wherein the wall segment comprises a first lightweight concrete layer defining a first external side, a second lightweight concrete layer defining a second external side and a mesh layer within at least one of the first concrete layer or the second concrete layer, a metal frame, a third lightweight concrete layer between the first and second concrete layers placed within openings in the metal frame, thermal ply layer covering the third lightweight concrete layer, and a lathe and thermal ply layer defining an external side.

11. The prefabricated wall system according to claim 10, wherein the wall segment further comprises a material provided to define an area during construction of the wall which is removable once each lightweight concrete layer is cured.

12. The prefabricated wall system according to claim 1, wherein the wall segment further comprises steel tension rods positioned therethrough a metal frame between two external sides of the wall segment.

13. The prefabricated wall system according to claim 1, wherein the wall segment comprises at least one of a first lightweight concrete layer and/or a board with magnesium oxide defining a first external side, at least one of a second lightweight concrete layer and/or a board with magnesium oxide defining a second external side, foam insulation therebetween the first and second lightweight concrete layer and/or first and second board with magnesium oxide.

14. The prefabricated wall system according to claim 1, wherein the wall segment comprises a first and a second thermal ply layer defining external sides, a metal frame, and an insulation barrier.

15. The prefabricated wall system according to claim 1, wherein the wall segment comprises a lightweight concrete layer defining an external side, a coating layer, an insulation barrier, a thermal ply layer, a metal frame, and an outer coating defining a second external side.

16. The prefabricated wall system according to claim 1, wherein the securing system further comprises at least one steel post vertically secured to a foundation wherein the wall segment is lowered onto the steel post for securing the wall segment.

17. The prefabricated wall system according to claim 6, wherein the securing system further comprises a steel beam secured to a top edge of the wall segment.

18. The prefabricated wall system according to claim 1, wherein the securing system further comprises at least one concrete post that is poured between an area defined by two adjacent wall segments.

19. The prefabricated wall system according to claim 18, wherein the securing system further comprises a concrete beam that is poured within a cavity defined on top of the wall segment.
